(19) United States
(12) Patent Application Publication
(10) Pub. No.: US 2013/0106484 A1
(43) Pub. Date: May 2, 2013

(54) REGULATED POWER SUPPLY VOLTAGE FOR DIGITAL CIRCUITS

(71) Applicant: Marvell World Trade Ltd., St. Michael (BB)

(72) Inventor: Sasan Cyrusian, Scotts Valley, CA (US)

(73) Assignee: MARVELL WORLD TRADE LTD., St. Michael (BM)

(21) Appl. No.: 13/661,946

(22) Filed: Oct. 26, 2012

Related U.S. Application Data
(60) Provisional application No. 61/554,913, filed on Nov. 2, 2011.

(51) Int. Cl. G05F 3/02

(52) U.S. Cl. 327/331

(57) ABSTRACT

An integrated circuit (IC) includes a sensing circuit that outputs a sense signal. An external power supply may receive the sense signal and adjust a power supply voltage to the IC. The sensing circuit may comprise an oscillatory circuit that outputs a time-varying signal. The sense signal is based on the time-varying signal.

### CROSS REFERENCE TO RELATED APPLICATIONS

The present disclosure claims priority to U.S. Provisional App. No. 61/554,913 filed Nov. 2, 2011, the content of which is incorporated herein by reference in its entirety for all purposes.

### BACKGROUND

Unless otherwise indicated herein, the approaches described in this section are not prior art to the claims in this application and are not admitted to be prior art by inclusion in this section.

The switching speed of complementary metal oxide semiconductor (CMOS) digital circuits can vary by nearly a factor of 2× due to process variations in manufacturing of the chips, ambient operating temperature, and variations of the power supply. Usually the user sets the value of the power supply voltage for the circuits so that all the chips work at all allowable temperatures. Furthermore, the digital power supply voltage is usually increased to ensure that variations of the digital power supply voltage over all conditions (e.g. voltage drop caused by current flowing through resistance and inaccuracies and voltage source) do not fall below the minimum limit required for the devices to operate. As a consequence, it is common practice to set the digital power supply voltage to a level that is larger than necessary (this is referred to as “headroom”). This results in unnecessary power dissipation.

### SUMMARY

Aspects of the disclosure provide an integrated circuit. The integrated circuit includes a power supply voltage input pin for inputting a power supply voltage from a power supply, a plurality of digital circuits including a digital circuit, a sense signal generator connected to the digital circuit and operable to generate a sense signal representative of an operating characteristic of the digital circuit, and a sense signal output pin for outputting the sense signal to the power supply. The power supply is controlled in accordance with the sense signal to regulate a level of the power supply voltage based on the sense signal.

In an embodiment, the operating characteristic of the digital circuit is an operating frequency and the sense signal is determined based on a relation between the operating frequency of the digital circuit and a reference frequency. In an example, the operating characteristic of the digital circuit varies with ambient temperature. The reference frequency is provided off-chip.

According to an aspect of the disclosure, the digital circuit includes an oscillatory circuit and the sense signal is based on a frequency of the oscillatory circuit. In an example, the oscillatory circuit is a ring oscillator or a voltage controlled oscillator (VCO).

Further, in an embedment, the integrated circuit includes a level shifter operative with the sense signal generator to shift a level of the sense signal by a predetermined amount. The shifted sense signal is provided to the sense signal output pin. The level shifter includes a multiplier circuit or a summing circuit. The sense signal generator generates an intermediate sense signal that is used to generate the sense signal, and the level shifter is operative to shift the intermediate sense signal.

In addition, in an embodiment, the digital circuit is a first digital circuit. The digital circuitry further includes a second digital circuit. The sense generator is further operable to connect to the first digital circuit or to the second digital circuit. The sense signal is representative of an operating characteristic of the first digital circuit or the second digital circuit. Further, in an example, the integrated circuit includes a phase locked loop (PLL) circuit. The digital circuitry is a VCO component of the PLL and the sense signal generator is a phase detector component of the PLL.

Aspects of the disclosure provide another integrated circuit. The integrated circuit includes a voltage input pin for inputting a power supply voltage, a plurality of digital circuits powered by at least the power supply voltage, and at least one sense circuit. The sense circuit includes a sensor operable to produce a time varying signal, a sense signal generator connected to the sensor and operable to generate a sense signal that is based on a frequency of the time varying signal, and a sense signal output pin to output the sense signal to a source of the power supply voltage. A level of the power supply voltage is regulated by the sense signal.

Further, in an embodiment, the integrated circuit includes a plurality of sense circuits and a selector connected to the plurality of sense circuits. The selector is operable to provide a sense signal from one of the sense circuits to the sense signal output pin. In an example, the sense signal is further based on a relation between the frequency of the time varying signal of the sensor and a reference frequency. For example, the sensor is a ring oscillator or a VCO.

Aspects of the disclosure provide a method for an integrated circuit. The method includes providing a power supply voltage of a power supply source to a digital circuit from among a plurality of digital circuits, generating a signal representative of an operating characteristic of the digital circuit and providing the generated signal to the power source to change a level of the power supply voltage based on the generated signal.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates a high level block diagram of an integrated circuit configuration in accordance with the present disclosure.

FIGS. 2 and 2A show illustrative embodiments of a sensing circuit.

FIGS. 3A and 3B illustrate examples of oscillatory circuits.

FIG. 4 is a flow chart explaining operation of an integrated circuit in accordance with the present disclosure.

FIGS. 5A-5D illustrate embodiments for providing margin.

FIGS. 6 and 6A illustrate additional embodiments of a sensing circuit.

FIG. 7 shows a distributed configuration of the sensing circuit.

FIG. 8 illustrates an off-chip controller.

FIGS. 9 and 10 show alternative configurations for distributing the sensing circuit.

### DETAILED DESCRIPTION OF THE EMBODIMENTS

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

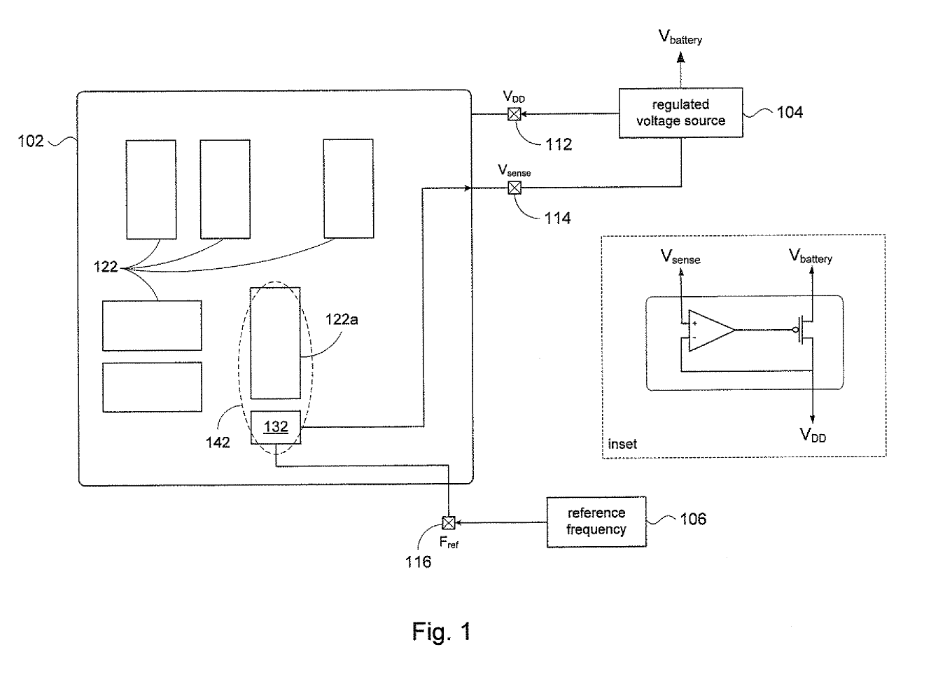

FIG. 1 shows an integrated circuit (IC) device 102 in accordance with embodiments of the present disclosure. The integrated circuit device 102 may include several pins for power supply potentials, data input and output, for passing control signals into and out of the device, and so on. FIG. 1 shows three pins in accordance with some embodiments, including a power supply pin 112, a sense voltage pin 114, and a reference frequency pin 116. The term “pins” as used herein may refer to pads, bonding pads, leads, lead frames, and so on depending on how the integrated circuit device 102 is packaged.

A regulated voltage source 104 may be connected to the integrated circuit device 102 at pin 112 and at pin 114. The regulated voltage source 104 may provide a power supply voltage (e.g., V_{DD}) to the integrated circuit device 102 via pin 112. As will be explained below, the regulated voltage source 104 may be controlled by a sense voltage Vₛₑₙₛₑ at pin 114. The inset in FIG. 1 shows an example of a low drop-out voltage source that may serve as the regulated voltage source 104. It will be appreciated of course that any other controllable voltage source may be used; for example, a switched power supply. In some embodiments, such as shown in FIG. 1, the regulated voltage source 104 will increase the level of the power supply voltage V_{DD} as Vₛₑₙₛₑ increases, and vice versa. This aspect of the present disclosure will be discussed in more detail below.

A reference frequency source 106 may be connected to the integrated circuit device 102 at pin 116 to provide a reference frequency (F_{ref}) to the integrated circuit device. In accordance with the present disclosure, the reference frequency source 106 provides a substantially constant reference frequency to be used by the integrated circuit device 102. The reference frequency source 106 is depicted in FIG. 1 as an “off-chip” circuit in that the reference frequency source is not formed in the integrated circuit device 102, but rather is provided as a separate device. It will be appreciated, however, that in some embodiments (not shown), the reference frequency source 106 may be on-chip.

In some embodiments, the integrated circuit device 102 may comprise digital circuitry. The digital circuitry may be organized into several sections of digital circuitry 122, for example by functionality. A microprocessor chip, for instance, may have an instruction pipeline section, a central processing unit section, a cache memory section, and so on. Although the embodiment depicted in FIG. 1 shows the digital circuitry partitioned into sections of digital circuits, it is noted that in other embodiments the digital circuitry comprising the integrated circuit device 102 may be arranged in other suitable configurations.

In accordance with principles of the present disclosure, the integrated circuit device 102 may include a speed sensing circuit 132. The speed sensing circuit 132 may receive the reference frequency F_{ref} from pin 116. The speed sensing circuit 132 may produce an output Vₛₑₙₛₑ that can be output via pin 114. As will be explained in more detail below, the speed sensing circuit 132 may serve to provide an indication of the actual speed or circuit delays of circuitry 122a (e.g., logic gates) formed in the vicinity 142 of the speed sensing circuit 132.

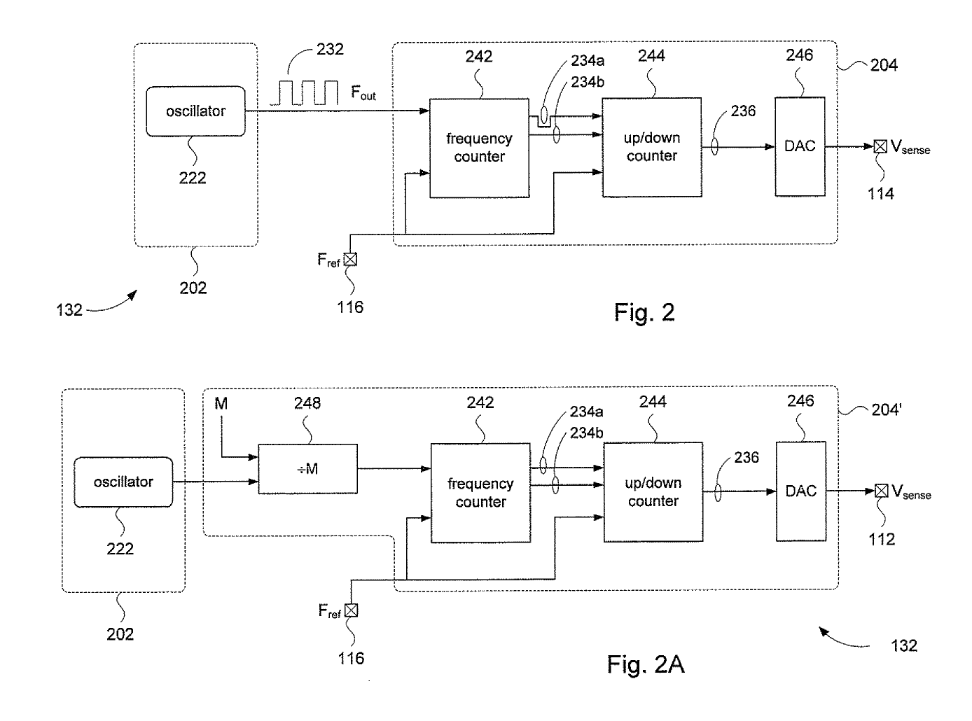

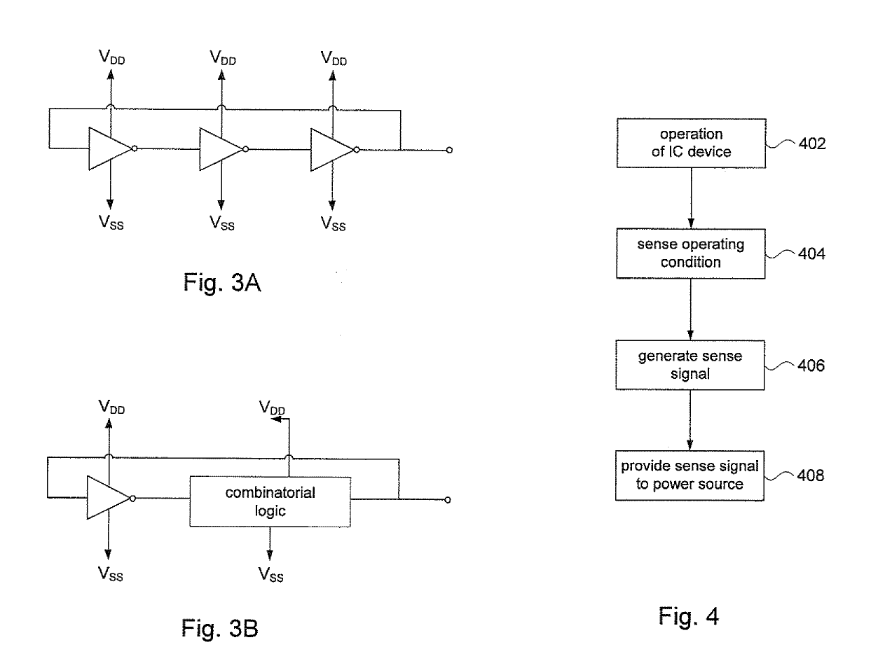

In some embodiments, as illustrated in FIG. 2, the speed sensing circuit 132 comprises a sensor circuit 202 which outputs a time varying signal 232, such as a square wave, at some frequency Fₒᵤₜ that is determined from the design of the sensor circuit. In some embodiments, the sensor circuit 202 may comprise a digital oscillator circuit 222. Referring to FIG. 3A, for example, the sensor circuit 202 may comprise a conventional ring oscillator circuit comprise a series of inverters connected in cascade. In other embodiments, the sensor circuit 202 may comprise a ring oscillator circuit implemented using combinatorial logic, such as shown in FIG. 3B, instead of the inverter cascade shown in FIG. 3A. In still other embodiments, the sensor circuit 202 may comprise other known oscillatory circuits.

Continuing with FIG. 2, the speed sending circuit 132 further comprises a sense signal generator 204 that receives an output of the sensor circuit 202, and produces a sense signal Vₛₑₙₛₑ. For example, in the embodiment shown in FIG. 2, the output is a time varying signal 232 generated by the oscillator 222 which is received by the sense signal generator 204. In some embodiments, the sense signal generator 204 may comprise a frequency counter 242, an up/down counter 244, and a digital-to-analog converter (DAC) 246.

The frequency counter 242 receives the reference frequency F_{ref}, and compares the frequency Fₒᵤₜ of the time varying signal 232 with the reference frequency F_{ref}. In some embodiments, the frequency counter 242 may be configured to generate an output 234a having a logic HI when Fₒᵤₜ<F_{ref} and a logic LO when Fₒᵤₜ>F_{ref}. An output 234b may be logic LO when Fₒᵤₜ≠F_{ref}, and logic HI when Fₒᵤₜ≠F_{ref}.

The outputs 234a and 234b of the frequency counter 242 are connected to the up/down counter 244, the up/down counter 244 may be configured to count up when the output 234a is at logic HI and output 234b is at logic LO, and to count down when the output 234a is at logic LO and output 234b is at logic LO. The up/down counter 244 may be configured to stop counting and present its current count value at output 236 when the output 234b from the frequency counter 242 is logic HI. The counting speed of the up/down counter 244 may be set by the reference frequency F_{ref}. The output 236 of the up/down counter 244 is a digital count value which is received by the DAC 246, the DAC 246 converts the output 236 of the up/down counter 244 to produce the sense signal Vₛₑₙₛₑ. In a particular embodiment, the up/down counter 244 may be a 10-bit counter (i.e., the output 236 is a 10-bit value) and the DAC 246 is a 10-bit DAC. Of course, other bit resolutions are possible.

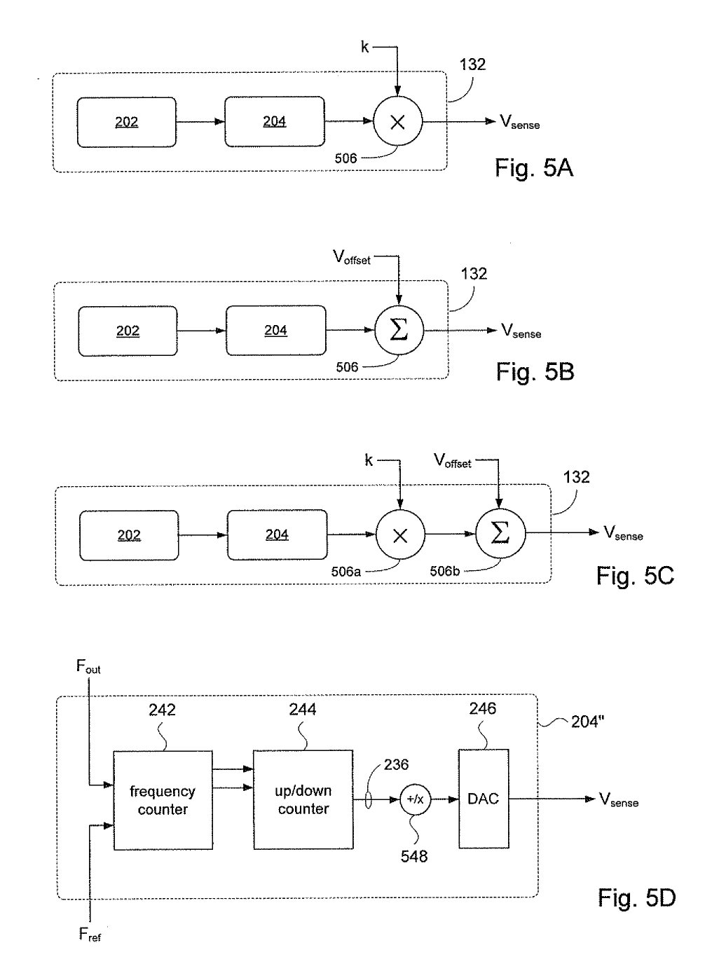

Referring now to FIG. 4, at 402, during operation of the integrated circuit device 102, if the ambient temperature varies in the vicinity 142 of the speed sensing circuit 132 (e.g., a thermal hotspot), the operating characteristics of the sensor circuit 202 may vary. For example, the timing characteristics (e.g., gate speed, parasitic capacitances, resistances) of the devices that comprise the oscillator 222 may change as the temperature changes. It will be appreciated of course that other conditions may affect the timing characteristics of the devices, for example, local mechanical stress. As a result, the frequency Fₒᵤₜ of the output signal 232 generated by the oscillator 222 may vary up or down. In accordance with the present disclosure, the frequency Fₒᵤₜ of the output signal 232 is sensed (block 404), for example, by the frequency counter 242.

At 406, when the frequency Fₒᵤₜ of the output signal 232 falls below the reference frequency F_{ref}, the frequency counter 242 will output a logic HI at its output 234a and a logic LO at its output 234b. The up/down counter 244 will count up (i.e., increment the digital output 236) when it receives the HI logic Level at 234a. Conversely, when the frequency Fₒᵤₜ of the output signal 232 rises above the reference frequency F_{ref}, the frequency counter 242 will output a logic LO at its output 234a (output 234b remains LO). The up/down counter 244 will count down (i.e., decrement the digital output 236) when it receives a LO logic Level at 234a. When Fₒᵤₜ becomes equal to F_{ref}, then the output 234b will go to logic HI and the up/down counter 244 will stop counting and hold its output 236 at the current count value.

The digital output 236 of the up/down counter 244 is converted to an analog signal by the DAC 246, which constitutes the sense signal Vₛₑₙₛₑ that is connected to pin 114. As the up/down counter 244 is counting up or down, the digital output 236 will be changing, and so the voltage level of the sense signal Vₛₑₙₛₑ will likewise vary. Therefore, the sense signal Vₛₑₙₛₑ will track variations in the frequency Fout of the output signal 232, and thus may serve to represent an operating characteristic of the oscillator 222. In some embodiments, as described above, the sense signal Vₛₑₙₛₑ may vary in direct proportion with the frequency Fₒᵤₜ; i.e., as Fₒᵤₜ increases so will Vₛₑₙₛₑ and conversely as Fₒᵤₜ decrease so will Vₛₑₙₛₑ. In other embodiments, the sense signal Vₛₑₙₛₑ may vary in inverse proportion with the frequency Fₒᵤₜ; i.e., as Fₒᵤₜ increases, Vₛₑₙₛₑ will decrease and as Fₒᵤₜ decreases, Vₛₑₙₛₑ will increase. This can be accomplished, for example, by reversing the response of the up/down counter 244 to logic HI and logic LO at the output 234a.

At 408, the sense signal Vₛₑₙₛₑ may be provided to the regulated voltage source 104 (FIG. 1) via pin 114. As explained above, the regulated voltage source 104 will increase the power supply voltage level V_{DD} as the sense signal Vₛₑₙₛₑ increases, and vice versa. Thus, if operating conditions vary so as to reduce the speed of the oscillator 222, the resulting decrease in Fₒᵤₜ may cause a corresponding increase in Vₛₑₙₛₑ (if Fₒᵤₜ<F_{ref}), which in turn will control the regulated voltage source 104 to increase the power supply voltage level. The resulting increase in the power supply voltage V_{DD} that is supplied to the integrated circuit device 102 will increase the operating speed of the switching devices comprising the integrated circuit device. Conversely, if operating conditions vary so as to increase the speed of the oscillator 222, the resulting increase in Fₒᵤₜ will cause a corresponding decrease in the level of the sense signal Vₛₑₙₛₑ (if Fₒᵤₜ>F_{ref}), causing the regulated voltage source to lower V_{DD}. The resulting decrease in the power supply voltage V_{DD} will decrease the operating speed of the switching devices comprising the integrated circuit device. The feedback provided by adjusting the power supply voltage VDD will cause Fₒᵤₜ to become equal to F_{ref}, and when that happens Vₛₑₙₛₑ remains constant, thus maintaining a constant level of the power supply voltage V_{DD}. Thus, the reference frequency F_{ref} can be set to establish a desired operating speed of the devices in integrated circuit device 102.

Referring to FIG. 1, by physically locating the speed sensing circuit 132 in the vicinity 142 of a circuit section (e.g., section 122a) of the integrated circuit device 102, the speed sensing circuit can be subjected to the same voltage drop over the power rail and the ground rail as that circuit section. More generally, the speed sensing circuit 132 may be subjected to the similar operating environment as the circuit section 122a. For example, devices comprising the speed sensing circuit 132 and the devices comprising the circuit section 122a will be subject to very similar process conditions during fabrication of the integrated circuit device 102 by virtue of their proximity to each other. In addition, the metal routing of the speed sensing circuit 132 can be designed such that the parasitic metal capacitance, resistances, RC time constants, and so on are representative of the metal routing used for the digital gates of the circuit section 122a. Thus, any effects on switching speed in the circuit section 122a due to operating conditions will also be experienced by the speed sensing circuit 132. And when the speed sensing circuit 132 causes the power supply voltage V_{DD} to be adjusted so as to restore the switching speed of its devices based on the reference frequency F_{ref}, the switching speed of the devices comprising the circuit section 122a may also be similarly restored.

Embodiments in accordance with the present disclosure may be advantageous if the circuit section 122a contains critical timing paths, the speed sensing circuit 132 can serve to regulate the power supply voltage V_{DD} so as to maintain a substantially constant power supply voltage level despite changes in operating conditions (such as ambient temperature), and thus maintain a substantially constant operating speed of the critical timing paths in the circuit section 122a.

Another advantage relates to V_{DD} headroom. Conventionally, the power supply voltage V_{DD} is selected with a certain amount of headroom to allow the device to operate over a range of operating conditions. Typically, V_{DD} headroom can be on the order of >1 volt. However, when the additional headroom is not needed, that power is wasted and dissipates as heat. Embodiments in accordance with the present disclosure may allow the integrated circuit device 102 to operate with a lower power supply voltage V_{DD}, and thus can significantly reduce the headroom. As operating conditions vary, the speed sensing circuit 132 can adjust the regulated voltage source 104 to supply more (or less) power to the integrated circuit device 102, the regulated voltage source 104 is adjusted as conditions vary to provide just enough power to the integrated circuit device 102, thus reducing (if not eliminating) wasted power.

Referring again to FIG. 2, the frequency Fₒᵤₜ of the output signal 232 may be much higher than the reference frequency F_{ref}. For example, it may be more convenient to design an oscillator 222 that operates at a high frequency due to the nature of the integrated circuit device 102; however, the reference frequency source 106 may be more conveniently designed to operate at a much lower frequency. A large maximum difference between Fₒᵤₜ and F_{ref} may require a large count value in to adequately track the difference, which will affect the size of the frequency counter 242, up/down counter 244, and DAC 246. Accordingly, in some embodiments such as shown in FIG. 2A, the speed sensing circuit 132 may comprise a sense signal generator 204′ that incorporates a frequency divider 248. The frequency divider 248 may include an input to specify a scalar value M as shown in FIG. 2A. By dividing down Fₒᵤₜ, the maximum difference between Fₒᵤₜ and F_{ref} can be reduced.

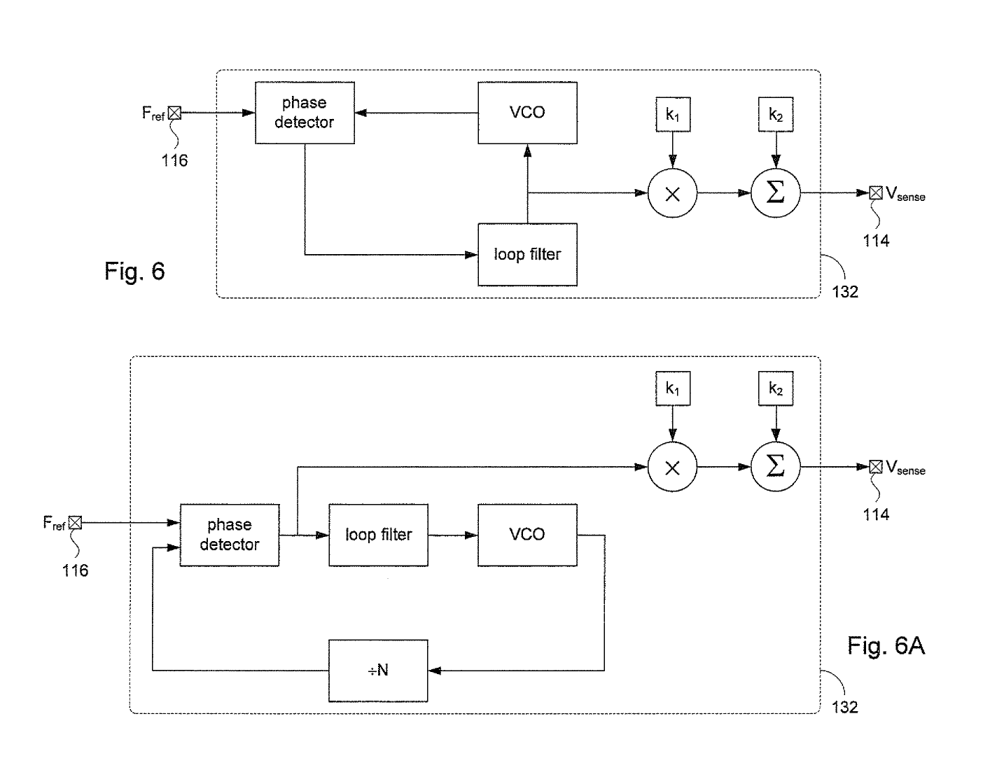

Referring now to FIGS. 5A-5D, in some embodiments, the speed sensing circuit 132 may include a margin in the sense signal Vₛₑₙₛₑ. The devices comprising the integrated circuit device 102 typically will not be identical in terms of their operating characteristics. Process variations, for example, may result in devices having varying minimum power supply voltage requirements (e.g., on the order to tens of millivolts). Accordingly, the power supply voltage V_{DD} that is supplied to the device 102 may include a margin. For example, if a nominal value for V_{DD} is 1 volt, then a margin of 50 mV may be added. In accordance with the present disclosure, the sense signal V_{signal} may be adjusted to include a margin in the power supply voltage.

FIGS. 5A-5C show several illustrative embodiments in accordance with the present disclosure that can incorporate a margin in the sense signal V_{signal}. In some embodiments, as shown FIG. 5A, the speed sensing circuit 132 may include a scaling element 506. In the particular embodiment shown in the figure, the scaling element 506 is a multiplier circuit that is connected to the output of the DAC 246 shown in FIG. 2. More specifically, the scaling element 506 may be an analog multiplier. A constant k may be provided to shift the level of the analog output (V_{DAC}) of the DAC 246 by a factor k, namely Vₛₑₙₛₑ=V_{DAC}×k. As FIG. 5B illustrates, in other embodiments, the scaling element 506 may be an analog summing circuit that shifts the V_{DAC} by an offset amount V_{offset}, namely Vₛₑₙₛₑ=V_{DAC}+V_{offset}.

FIG. 5C shows that the level of V_{DAC} may be shifted by a combination of multiplying and offsetting. The figure shows the speed sensing circuit 132 may comprise a multiplier 506a in series with an adder 506b. As shown, the sense signal Vₛₑₙₛₑ=V_{DAC}×k+V_{offset}. In some embodiments, the multiplier and adder may be reversed to produce Vₛₑₙₛₑ=(V_{DAC}+V_{offset})×k.

Referring to FIG. 5D, in some embodiments, the speed sensing circuit 132 may comprise a sense signal generator 204″ that shifts the level of the sense signal Vₛₑₙₛₑ by shifting the output of the up/down counter 244. The sense signal generator 204″ includes a scaling element 548. The scaling element 548 is disposed at the output 236 of the up/down counter 244. Similar to the configurations in FIGS. 5A-5C, in some embodiments, the scaling element 548 may be a digital multiplier circuit to multiply the digital output of the up/down counter 244. In other embodiments, the scaling element 548 may be a digital adder, and in still other embodiments the scaling element 548 may be a combination of multiplier and adder. The scaling element 548 is digital because the output of the up/down counter 244 is a digital quantity.

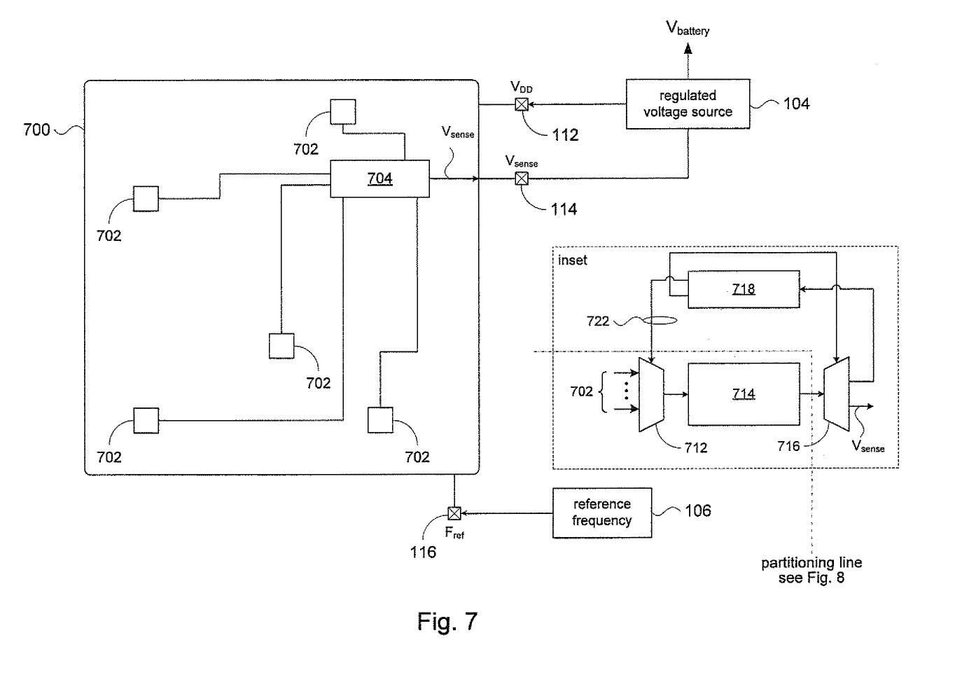

Referring now to FIG. 6, in some embodiments, the speed sensing circuit 132 may comprise a phase locked loop (PLL) circuit comprising a phase detector, a voltage controlled oscillator (VCO), and a loop filter. The role of the sensor circuit component 202 (FIG. 2) of the speed sensing circuit 132 is performed by the VCO. The role of the sense signal generator component 204 is performed by the phase detector and the loop filter. The sense signal Vₛₑₙₛₑ may be obtained from an output of the loop filter. The figure shows a scaling element comprising either or both a multiplier circuit (factor k1) and an adder circuit (offset k2) to include a margin in the sense signal Vₛₑₙₛₑ. The scaling element may be omitted in some embodiments.

In operation, the PLL operates to lock the frequency of the output signal of the VCO to the reference frequency F_{ref}. Since, the frequency of the output of the VCO may vary with the operating conditions of the integrated circuit device 102. The phase detector will detect the difference between the output of the VCO and the reference frequency F_{ref} and output an error signal. The error signal is filtered by the loop filter, and the output of the loop filter feeds back to control the VCO to lock to the reference frequency F_{ref}. The output of the loop filter, therefore, represents an operating characteristic of the VCO (namely its output frequency) and may serve as the sense signal Vₛₑₙₛₑ.

FIG. 6A shows an embodiment of a speed sensing circuit 132 comprising a PLL that has a divider (divide by N) circuit in the feedback loop. If the frequency of the VCO output is much greater than the reference frequency Fref, the divider circuit may be used to divide down the frequency of the VCO output. FIG. 6A additionally illustrates that, in some embodiments, the sense signal Vₛₑₙₛₑ may be taken from the output (i.e., the error signal) of the phase detector, rather than from the loop filter. Also, either or both of the multiplier and adder circuits may be provided. In some embodiments, the scaling circuits may be omitted.

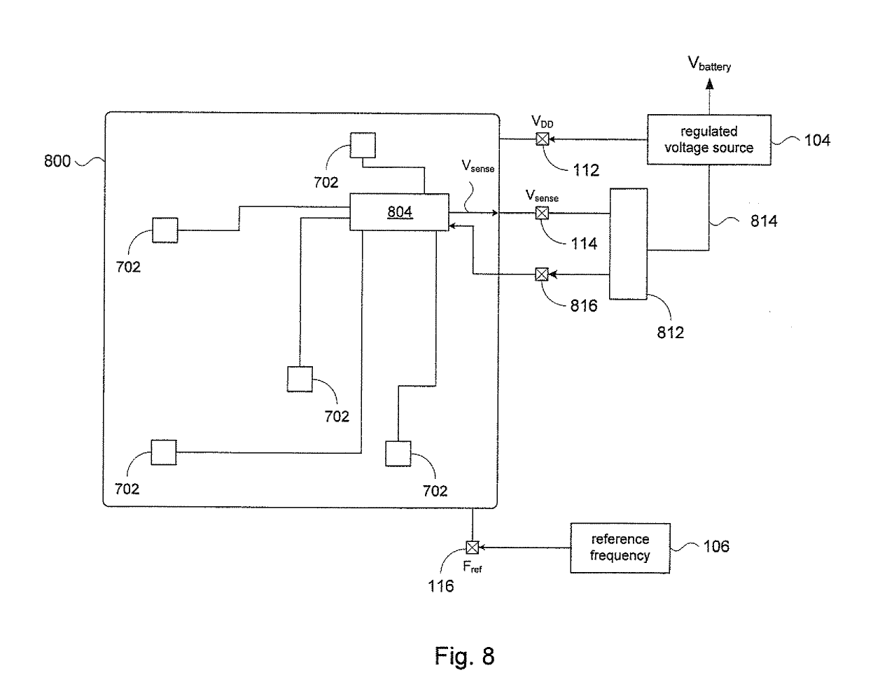

Recall in FIG. 2 that the speed sensing circuit 132 comprises a sensor circuit 202 and a sense signal generator 204. Referring now to FIG. 7, in some embodiments, an integrated circuit device 700 in accordance with the present disclosure may include a speed sensing circuit that comprises several sensor circuits 702 and a central sense signal generator 704 to which the outputs of the several sensor circuits are connected. Embodiments according to this aspect of the present disclosure may be used to cover large areas of digital circuitry where multiple different hot spots or other conditions that can affect device switching speeds may arise.

In some embodiments, the sensor circuits 702 may comprise a ring oscillator such as shown in FIGS. 3A and 3B, for example. The inset in FIG. 7 shows some details for the sense signal generator 704. The output of each of the sensor circuits 702 connects to a selector 712, which is operable to provide one of its multiple inputs to its output. The output of selector 712 connects to a signal generator 714. The signal generator 714 may comprise the circuitry 204 shown in FIG. 2. The output of the signal generator 714 connects to a selector 716, which is operable to provide its input to one of two outputs. One of the outputs of selector 716 carries the sense signal Vₛₑₙₛₑ and is connected to pin 114. The other output of selector 716 feeds into a controller 718. The controller 718 outputs control signals 722 to control the selectors 712 and 716. The selector 712 may be a digital multiplexer, since the inputs to the selector 712 are digital. The selector 716 may be a suitable analog selector circuit, since the input to the selector 716 is an analog signal. In some embodiments, the sense signal generator 714 may incorporate the scaling elements shown in FIGS. 5A-5D.

In operation, the controller 718 may initially set the selector 716 to provide the selector's input to the controller 718. The controller 718 may control the selector 712 to provide an output from one of the sensor circuits 702 to the signal generator 714. A candidate sense signal may be generated by the signal generator 714, which is then provided to the controller 718 via selector 716. This can be repeated for the output of each sensor circuit 702. The controller 718 may include decision making logic to choose one of the candidate sense signals to be the sense signal Vₛₑₙₛₑ. For example, Vₛₑₙₛₑ may be the largest of all the candidate sense signals. As another example, the controller 718 may be connected to other control logic, on-chip or off-chip, that tells the controller to select a particular one of the sensor circuits 702 as the source for generating Vₛₑₙₛₑ. This may be useful when the critical timing path changes to different areas of the integrated circuit device 700 at different times. When a particular area of the integrated circuit device 700 becomes time critical, the controller 718 may be instructed to select a nearby sensor circuit 702 as the source for generating Vₛₑₙₛₑ.

In other embodiments, the speed sensing circuits 132 shown in FIGS. 6 and 6A may be used. For example, each sensor circuits 702 may comprise a VCO. The central sense signal generator 704 may comprise the phase detector and loop filter, along with the optional scaling elements.

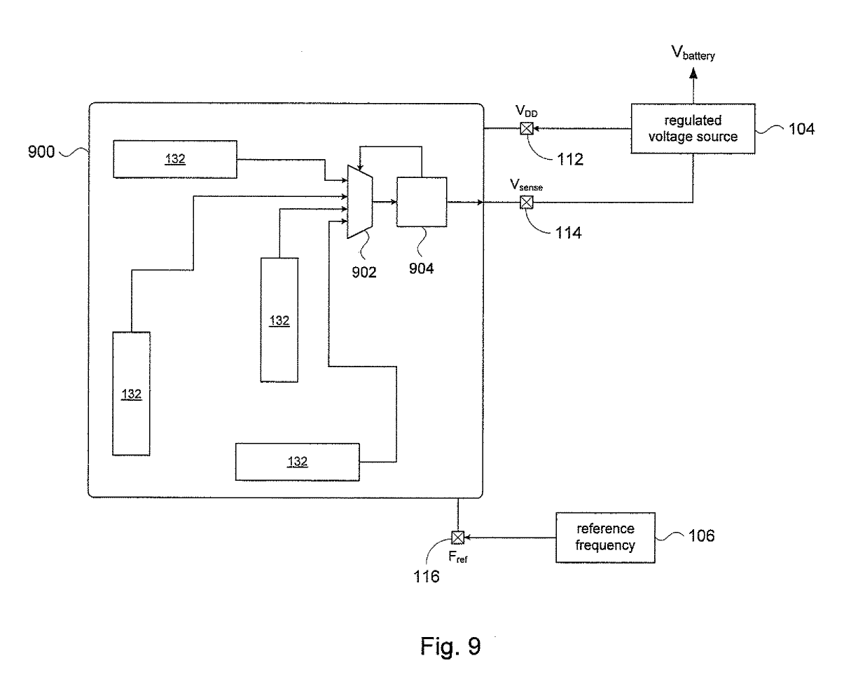

In some embodiments, the controller 718 in FIG. 7 may be provided off-chip, rather than on-chip as illustrated in the figure. This may be more suitable if greater sophistication is needed in the controller 718. Referring now to FIG. 8, an integrated circuit device 800 may comprise several sensor circuits 702. The outputs of the sensor circuits 702 may connect to a sense signal generator 804. The sense signal generator 804 outputs as Vₛₑₙₛₑ a sense signal that is based on a selected one of the sensor circuits 702. An off-chip controller 812 provides a control signal via pin 816 to control which sensor circuit 702 is selected by the sense signal generator 804. The selected sense signal is provided to the regulated voltage source 104 at an output 814 of the off-chip controller 812. In some embodiments, the sense signal generator 804 and the off chip controller 812 may comprise the sense signal generator 704 shown in FIG. 7 partitioned along the partitioning line shown in the figure.

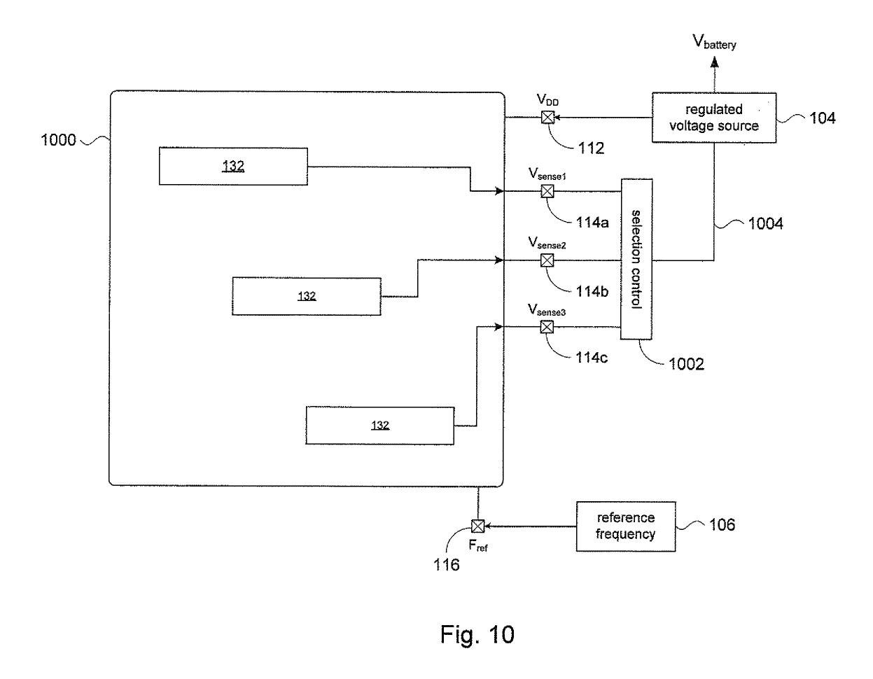

Referring to FIG. 9, in some embodiments, an integrated circuit device 900 may comprise replicas of the speed sensing circuit 132 placed in different areas in the integrated circuit device. The sense signal produced by each speed sending circuit 132 feeds into a selector 902. A controller 904 may select a suitable sense signal from among the incoming sense signals and output the selected sense signal as Vₛₑₙₛₑ on pin 114. The controller 904 may include decision making logic such as explained above to decide with speed sensing circuit to use for outputting the sense signal Vₛₑₙₛₑ. In some embodiments, the controller 904 may be an off-chip controller.

Referring to FIG. 10, in some embodiments, an integrated circuit device 1000 may comprise replicas of the speed sensing circuit 132 placed in different areas in the integrated circuit device. The sense signal produced by each speed sending circuit 132 may be output to a respective output pin 114a, 114b, 114c. Each sense signal Vₛₑₙₛₑ₁, Vₛₑₙₛₑ₂, Vₛₑₙₛₑ₃ may be provided concurrently to an off-chip selector 1002. A selected sense signal may then be provided on an output 1004 of the off-chip selector 1002.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present disclosure along with examples of how aspects of they may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the claims.

What is claimed is:

1. An integrated circuit comprising:
a power supply voltage input pin for inputting a power supply voltage from a power supply;
a plurality of digital circuits, including a digital circuit;
a sense signal generator connected to the digital circuit and operable to generate a sense signal representative of an operating characteristic of the digital circuit; and
a sense signal output pin for outputting the sense signal to the power supply, whereby the power supply is controlled in accordance with the sense signal to regulate a level of the power supply voltage based on the sense signal.

2. The integrated circuit of claim 1 wherein the operating characteristic of the digital circuit is an operating frequency and the sense signal is determined based on a relation between the operating frequency of the digital circuit and a reference frequency.

3. The integrated circuit of claim 2 wherein the operating characteristic of the digital circuit varies with ambient temperature.

4. The integrated circuit of claim 2 wherein the reference frequency is provided from a circuit that is off-chip.

5. The integrated circuit of claim 1 wherein the digital circuit comprises an oscillatory circuit and the sense signal is based on a frequency of the oscillatory circuit.

6. The integrated circuit of claim 5 wherein the oscillatory circuit is a ring oscillator or a voltage controlled oscillator (VCO).

7. The integrated circuit of claim 1 further comprising a level shifter operative with the sense signal generator to shift a level of the sense signal by a predetermined amount, the shifted sense signal being provided to the sense signal output pin.

8. The integrated circuit of claim 7 wherein the level shifter comprises a multiplier circuit or a summing circuit.

9. The integrated circuit of claim 7 wherein the sense signal generator generates an intermediate sense signal that is used to generate the sense signal, wherein the level shifter is operative to shift the intermediate sense signal.

10. The integrated circuit of claim 1 wherein the digital circuit is a first digital circuit, wherein the digital circuitry further comprises a second digital circuit, wherein the sense generator is further operable to connect to the digital circuit or to the second digital circuit, wherein the sense signal is representative of an operating characteristic of the digital circuit or the second digital circuit.

11. The integrated circuit of claim 1 further comprising a phase locked loop (PLL) circuit, wherein the digital circuitry is a VCO component of the PLL and the sense signal generator is a phase detector component of the PLL.

12. An integrated circuit comprising:
a voltage input pin for inputting a power supply voltage;
a plurality of digital circuits powered by at least the power supply voltage;
at least one sense circuit comprising:
a sensor operable to produce a time varying signal;
a sense signal generator connected to the sensor and operable to generate a sense signal that is based on a frequency of the time varying signal; and
a sense signal output pin to output the sense signal to a source of the power supply voltage, wherein a level of the power supply voltage is regulated by the sense signal.

13. The integrated circuit of claim 12 further comprising a plurality of sense circuits and a selector connected to the plurality of sense circuits, the selector operable to provide a sense signal from one of the sense circuits to the sense signal output pin.

14. The integrated circuit of claim 12 wherein the sense signal is further based on a relation between the frequency of the time varying signal of the sensor and a reference frequency.

15. The integrated circuit of claim 12 wherein the sensor is a ring oscillator or a VCO.

16. The integrated circuit of claim 12 further comprising a level shifter operative with the sense signal generator to shift the sense signal by a predetermined amount, the shifted sense signal being provided to the sense signal output pin.

17. A method for an integrated circuit comprising:
providing a power supply voltage of a power supply source to a digital circuit from among a plurality of digital circuits;
generating a signal representative of an operating characteristic of the digital circuit; and
providing the generated signal to the power source to change a level of the power supply voltage based on the generated signal.

18. The method of claim 17 wherein the operating characteristic of the digital circuit varies with ambient temperature of the integrated circuit, and the power supply voltage level thereby varies with the ambient temperature.

19. The method of claim 17 wherein the digital circuit is an oscillatory circuit and the generated signal varies with a frequency of the oscillatory circuit.

20. The method of claim 17 wherein the digital circuit is a ring oscillator or a VCO.
